(19) United States
(12) Patent Application Publication
(10) Pub. No.: US 2007/0136332 A1
(43) Pub. Date: Jun. 14, 2007

(54) SYSTEM FOR MANAGING A USER DEFINED TYPE IN A DATABASE

(76) Inventor: Thomas Nolan, San Diego, CA (US)

Correspondence Address: JAMES M. STOVER;NCR CORPORATION, 1700 SOUTH PATTERSON BLVD, WHQ4, DAYTON, OH, 45479, US

(21) Appl. No.: 11/564,991

(22) Filed: Nov. 30, 2006

Related U.S. Application Data
(60) Provisional application No. 60/741,393, filed on Dec. 1, 2005.

(51) Int. Cl. G06F 7/00

(52) U.S. Cl. 707/100

(57) ABSTRACT

A system for managing a user defined type (UDT) in a database. The system includes an interface for receiving data indicative of the UDT. A processor is responsive to the data for defining a language specific information package for UDT, presently in the form of a Java class file representative of the UDT. An output provides the class file to a storage directory, in the form of a data dictionary maintained by the database. As, such class file is accessible by an application interacting with the database.

### FIELD OF THE INVENTION

The present invention relates to a system for managing a user defined type (UDT) in a database. The invention has been primarily developed for facilitating the use of UDTs by Java applications, and will be described by reference to that purpose. However, the invention is by no means restricted as such, and is readily implemented for managing UDTs in a broader sense.

### BACKGROUND

Any discussion of the prior art throughout the specification should in no way be considered as an admission that such prior art is widely known or forms part of common general knowledge in the field.

It is known to define a User-Defined Type (UDTs) for a database system. It is also known for Java applications to make use of a defined UDT. For example: in conjunction with a customized type mapping scheme defined the Java database connectivity (JDBC) driver of the database. Before a Java application is able to make such use, some tasks typically require manual completion. These are set out below:
(a) Creation of Java source code representative of the UDT.
(b) Compiling of the Java source code to define a Java class file.
(c) Making the Java class file physically available to the relevant Java application.
(d) Configuring the classpath used by the Java application to include the Java class file.
(e) Coding the Java application to call the JDBC driver's Connection .setTypeMap method to establish a customized type mapping.
(f) Coding knowledge of all fully-qualified UDT type names and their corresponding Java classes into the application.

When a UDT is changed in the database system, some of the tasks often need to be repeated.

The above sequence of tasks is manually programmed, time consuming and typically error-prone. For example, consistency between the Java class files used by the application and the UDTs defined in the database system is not ensured. If a UDT is changed in the database system such that it is incompatible with the Java class file used by the application, the application will likely fail. If a new UDT is defined in the database system, and values for that new UDT are stored in the database, but the Java application does not have a corresponding Java class file for that new UDT, the application will likely fail for queries that return the new UDT values.

### SUMMARY

It is an object of the present invention to overcome or ameliorate at least one of the disadvantages of the prior art, or to provide a useful alternative.

In accordance with a first aspect of the invention, there is provided a system for managing a user defined type (UDT) in a database, the system including:
an interface for receiving data indicative of the UDT;
a processor responsive to the data for defining a language specific information package for the UDT; and
an output for providing the information package to a storage directory such that the information package is accessible by an application interacting with the database.

Preferably the language specific information package is a Java class file representative of the UDT. More preferably the processor defines a first data packet indicative of Java source code for the UDT. Even more preferably the processor compiles the Java source code to define a second data packet indicative of the Java class file. Still preferably the second packet includes data indicative of class file byte codes for the Java class file.

The processor preferably leverages a Java compiler inherent to the database for compiling Java source code to define the Java class file. Preferably, the processor is responsive to an alteration to the Java source code for making a corresponding alteration to the Java class file.

Preferably the database implements a gateway volume, and the second data packet is accessible to the Java application through the gateway volume. In some embodiments the gateway volume includes either or both of a CIFS gateway process and a NFS gateway.

The Java application preferably has a classpath including the gateway volume.

Preferably the storage directory includes a CLOB column for maintaining the first data packet. More preferably the storage directory includes a BLOB column for maintaining the second data packet.

Preferably the database implements a predefined JDBC protocol having a SQLData interface, and the processor leverages the SQLData interface for defining the Java class.

In some embodiments the storage directory is a data dictionary table. Preferably the table holds a definition for the UDT.

According to a second aspect of the invention, there is provided database including:
a UDT definition; and
a table including a column for maintaining a Java class file representative of the UDT definition, the column being accessible by a Java application.

Preferably the database includes a data dictionary, and the column is a BLOB column within this data dictionary. More preferably the database includes a system for automatically defining the Java class file in response to creation or modification of a UDT for the database.

According to a further aspect of the invention, there is provided a method for managing a user defined type (UDT) in a database, the method including the steps of:
receiving data indicative of the UDT;
being responsive to the data for defining a language specific information package for the UDT; and
providing the information package to a storage directory such that the information package is accessible by an application interacting with the database.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a system according to an embodiment of the invention;

FIG. 2 is a flowchart illustrating an exemplary method for managing a UDT in accordance with an embodiment of the invention;

FIG. 3 is a flowchart illustrating an exemplary method of interaction between a Java application and a database; and

FIG. 4 shows in greater detail a portion of the representation of FIG. 1.

### DETAILED DESCRIPTION

Referring to the drawings, it will be appreciated that, in the different figures, corresponding features have been denoted by corresponding reference numerals.

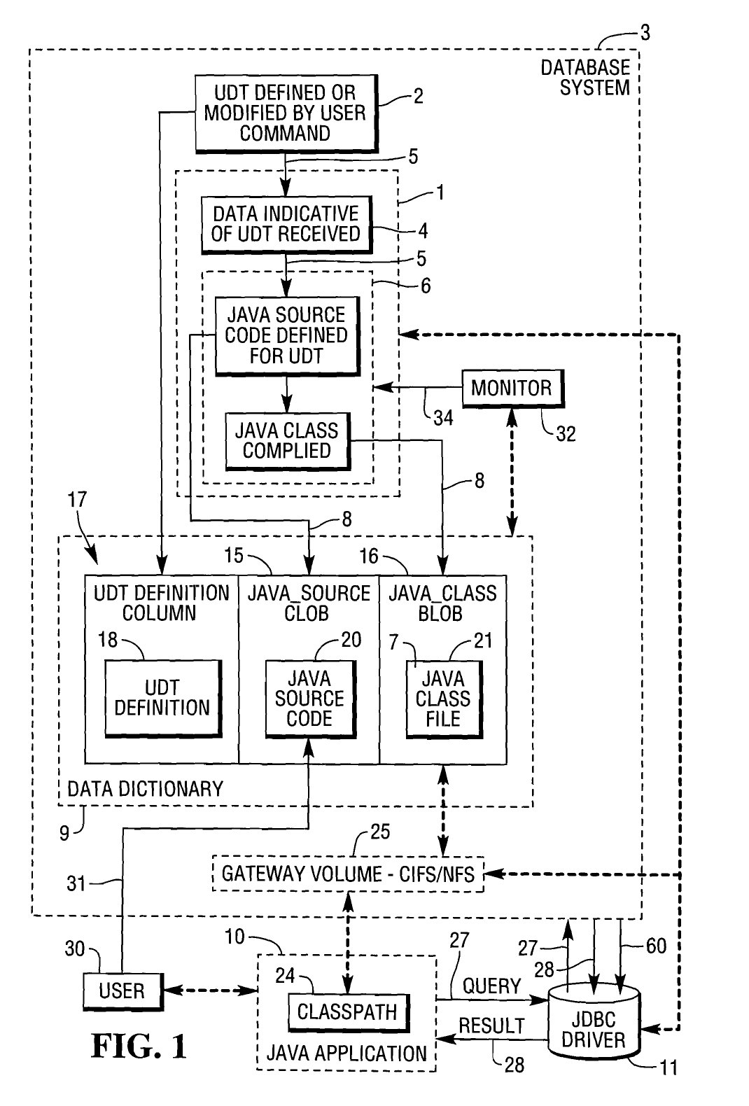

FIG. 1 illustrates a system 1 for managing a user defined type (UDT) 2 in a database 3. System 1 includes an interface 4 for receiving data 5 indicative of UDT 2. A processor 6 is responsive to data 5 for defining a language specific information package for UDT 2, presently in the form of a Java class file 7 representative of UDT 2. An output 8 provides class file 7 to a storage directory, in the form of a data dictionary 9 maintained by database 3. As such, class file 7 is accessible by an application 10 interacting with the database 3.

Although embodiments of the invention are described by particular reference to the Java language, it is appreciated that some embodiments are implemented in respect of alternate languages.

It is assumed that database 3 includes certain generic components and functionalities required to allow Java application interaction. In particular: a JDBC driver 11. References to particular Java functionalities, terminologies, and so on should not be regarded as limiting. Those skilled in the art will readily recognize functional equivalents where they exist, and understand how these equivalents are used in alternate embodiments.

Although embodiments are described by reference to a single UDT 2, it is appreciated that system 1 practically manages a plurality of UDTs. A single UDT is considered for the sake of convenient example.

In brief, system 1 is configured to substantially automatically allow application 10 to use UDT 2 upon creation or modification of UDT 2. That is, creation of UDT 2 does not give rise to particularly onerous coding nuances that must be implemented in application 10. Application 10 uses UDT 2 in conjunction with a customized type mapping interface provided by JDBC driver 11. The underlying rationale is that system 1 maintains class file 7 such that application 10 need not inherently carry that information. Further, system 1 uses functionalities inherent to database 3—and specifically driver 11—to automatically carry out processes in response to predefined stimuli. More specifically, this solution is an enhancement of a User-Defined Type (UDT) facility inherent to database 3. The solution involves a modification dictionary 9 of database 3. In particular, dictionary 9 is modified for maintaining a character large object (CLOB) column 15 for storing UDT Java source code and a binary large object (BLOB) column 16 for UDT Java class files. These columns are maintained in a data dictionary table 17 that inherently holds the UDT definition 18 for UDT 2.

In the first instance, a user defines UDT 2 by way of a CREATE TYPE command. This is carried out in a manner conventional to database 3, for example by use of an appropriate tool and/or console. Data 5 indicative of this UDT is provided to interface 4. In some cases, database 3 is configured to automatically provide this data. In other embodiments system 1 includes a monitoring utility responsive to a CREATE TYPE command for obtaining data 5 and providing this data to interface 4.

The precise nature of data 5 varies between embodiments. In functional terms, data 5 needs to provide interface 4 with sufficient information about UDT 2 to allow creation of class file 7. In some cases data 5 is in the form of input provided as part of the CREATE TYPE command, whilst in other cases the input is processed and re-formatted for the purpose of interface 4. Data 5 is often indicative of UDT definition 18 inherently maintained within table 17. Alternately, data 5 is indicative of a location from where the relevant information is obtainable.

Upon data 5 being received by interface 4, processor 6 defines a first data packet 20 indicative of Java source code corresponding to UDT 2. This is defined by reference to a SQLData interface provided by driver 11 such that customized type mapping of UDT values to and from Java objects is facilitated. Once this first packet is defined, it is exported by output 8 for storage in CLOB column 15 such that table 17 associates packet 20 with UDT definition 18. Column 15 is also referred to as the JAVA_SOURCE CLOB column.

Also in response to the creation of packet 20, processor 6 compiles the Java source code held in packet 20 to define a second data packet 21. This second packet is indicative of Java class file 7. More specifically, this packet includes the relevant Java class file byte codes for file 7. Processor 6 advantageously leverages a Java compiler inherent to database 3 to facilitate this compiling.

Once packet 21 is defined, it is exported by output 8 for storage in BLOB column 16 such that table 17 associates packet 21 with UDT definition 18. Column 16 is also referred to as the JAVA_CLASS BLOB column.

Database 3 implements a gateway volume 25, including either or both of a common internet file system (CIFS) and a network file system (NFS). Typically, a CIFS access is provided for Microsoft Windows client systems, and a NFS gateway volume is provided for UNIX and Linux client systems. Volume 25 provides provide read-only file system-based access to the contents of column 16, this access being available to application 10. Each Java class—such as that provided by file 7—stored in the JAVA_CLASS BLOB column is appears in the form of a “.class” file available through volume 25.

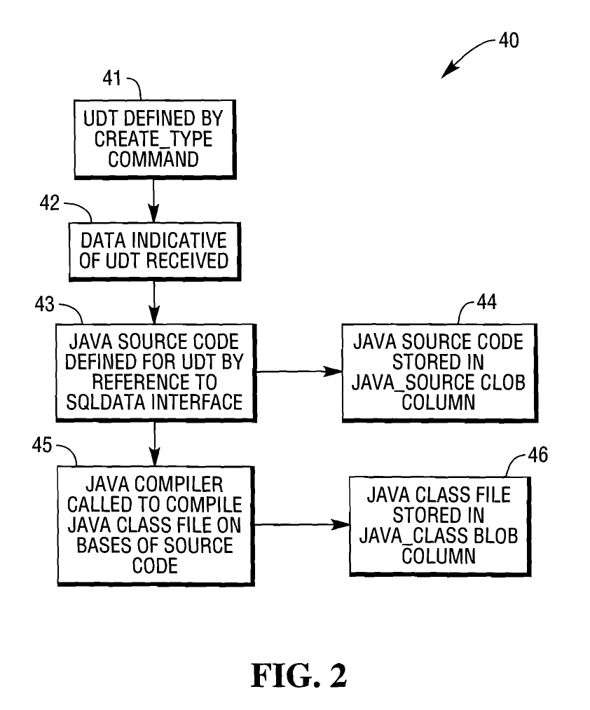

An exemplary method 40 carried out by system 1 following creation of UDT 2 is provided in FIG. 2. In overview, a UDT is defined at 41 by way of a CREATE_TYPE command. Data indicative of the UDT is received at 42. At 43 this data is used to define Java source code on the basis of the SQLData interface for the relevant JDBC driver. This source code is stored in the JAVA_SOURCE CLOB column at 44. At 45 a Java compiler is called to compile the source code for defining a Java Class file. This class file is stored in the JAVA_CLASS BLOB column at 46.

System 4 monitors not only the creation of a new UDT 2, but also the modification of an existing UDT 2. It will be appreciated that this is advantageous given that modification of a UDT typically requires corresponding modification to Java applications in prior art situations. There are two primary manners by which a UDT is modified, these being by way of user MODIFY_TYPE command, or by direct modification of the source code in packet 20.

Interface 4 is enabled to receive data 5 indicative of a MODIFY_TYPE command. In response, processor 6 treats this data 5 in a similar manner to that described above. The major difference is that an existing row in table 17 is updated, rather than a new row being created. That is: existing packets 20 and 21 are replaced by new packets 20 and 21, these new packets being representative of the modified UDT.

The Java source code stored in the JAVA_SOURCE CLOB column is available to be queried as a conventional CLOB column value, including modification or alteration by a user 30 if desired. For example: a user 30 provides a signal 31 indicative of a command to modify the source code of packet 20. System 1 includes a monitor 32 that obtains details of any such modification. FIG. 1 shows monitor 32 as monitoring data dictionary 9, although in other embodiments monitor 32 is directly responsive to signal 31. Where a packet 20 is modified, monitor 32 provides data 34 indicative of this modification to processor 6. In response, processor 6 automatically invokes the Java compiler to compile an appropriate modified Java class file. This class file is used to define a new packet 21, and output 8 replaces the relevant existing packet 21 with this new packet 21.

Where signal 31 modifies a JAVA_SOURCE CLOB column value to be NULL, monitor 32 and processor 6 combine to set the corresponding JAVA_CLASS BLOB column value to be NULL. This has an effect of removing Java class support for that particular UDT.

It is necessary to initialize application 10 to take advantage of the functionality of system 1. This is relatively easy, particularly when compared with tasks required to enable UDT usage in prior art scenarios. Specifically, the classpath 24 of application 10 is configured to include volume 25. This task need only be completed manually on a single occasion for application 10 in relation to database 3. Afterwards, this configuration ensures that all UDTs defined in the entire database system are made available to the application as a result of the single classpath setting. This differs from prior art situations where such a step was typically necessary each time a new UDT was defined.

A user connects (for example by mapping a drive or mounting) to gateway volume 25 to allow configuring of classpath 24. Once the classpath of application 10 is configured to include volume 25, application 10 is provided with access to class file 7, along with any other class files automatically generated for the UDT defined in the database via system 1.

In some embodiments, rather than configuring classpath 24, it is preferable to configure a classpath of an application server that hosts application 10. By such an approach, application 10 is provided with access to class file 7 by virtue of hosting on the application server. Those skilled in the art will recognize whether this approach is more preferable or appropriate in a given situation.

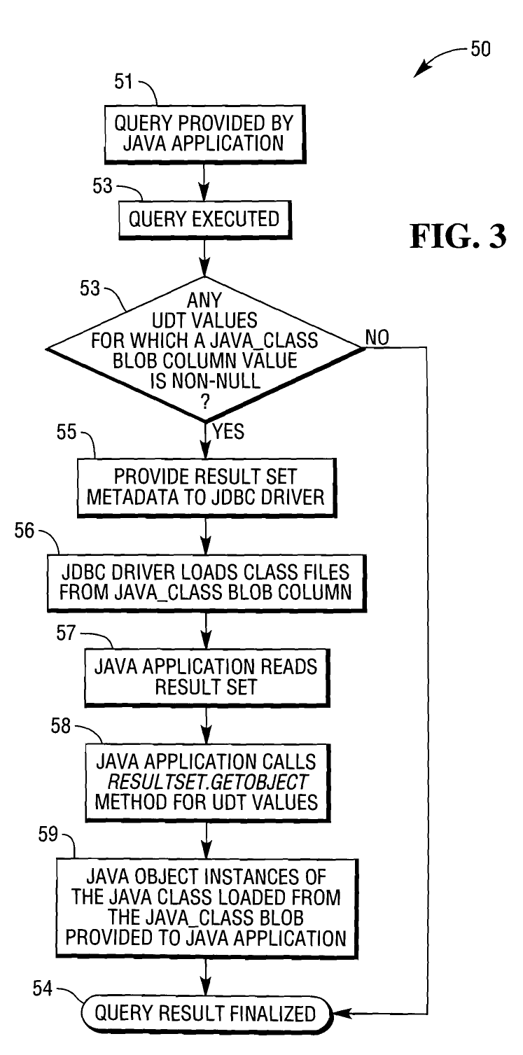

A method 50 illustrating an exemplary interaction between application 10 and database 3 is provided in FIG. 3. At 51 application 10 provides a query 27 to database 3, typically in the form of a SQL SELECT statement. This query is executed in the conventional manner at 52. At 53 it is decided whether the query returns UDT values for which a JAVA_CLASS BLOB column value is non-NULL. Where only NULL values are returned, system 1 is of little relevance, and the process completes at 54. Otherwise database 3 provides result set metadata 60 to the JDBC driver at 55 to inform the driver that a system-provided customized type mapping is available. Specifically, database 3 provides the Java class name that matches the “.class file” name in package 21. This is available through the gateway volume. Assuming the classpath is correctly configured, JDBC driver 11 loads the relevant class file 7 or files 7 via the gateway from the JAVA_CLASS BLOB column in the table 17 at 56. Application 10 then reads the result set at 57, and in so doing, calls the JDBC driver's ResultSet.getObject method for the UDT values at 58. It is appreciated that this is not always required. JDBC driver 11 provides Java object instances of the Java class loaded from the JAVA_CLASS BLOB column at 59. The process completes when a query result 28 is finalized at 54.

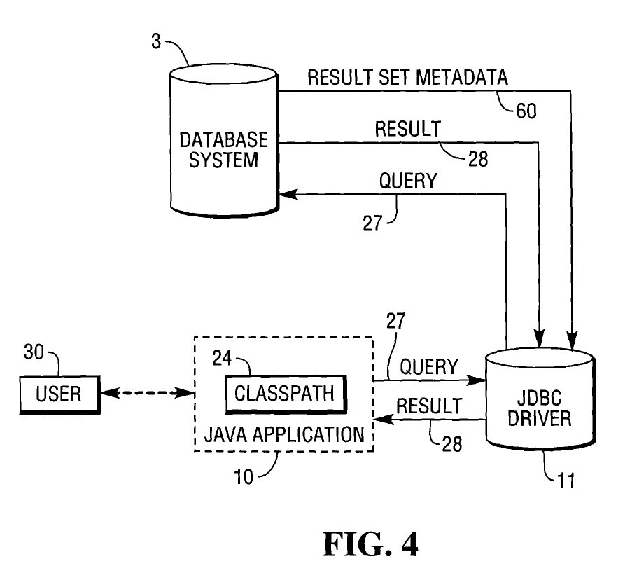

The respective paths of query 27, result 28 and metadata 60 is best shown in FIG. 4. It will be recognized that application 10 communicates with driver 11, which in turn communicates with database 3. Additionally, database 3 provides metadata 60 to driver 11 substantially concurrently with providing result 28.

It will be appreciated that the above disclosure reduces the need to carry out some of the tasks inherent to prior art systems, such as tasks (a) to (f) mentioned above. In particular, tasks (a) and (b) are automated. Task (c) is automated by making Java class files available via CIFS and/or NFS. Task (d) is still required, given that classpath 14 used by application 10 must be configured to include the Java class files, however this task is relatively easy and not highly prone to error. A need for task (e) is eliminated, given that customized type mapping is automatically provided by JDBC driver 11. Similarly, task (f) is not required given that customized type mapping is automatically provided by JDBC driver 11.

Although the present invention has been described with particular reference to certain preferred embodiments thereof, variations and modifications of the present invention can be effected within the spirit and scope of the following claims.

What is claimed is:

1. A system for managing a user defined type (UDT) in a database, the system including:
an interface for receiving data indicative of the UDT;
a processor responsive to the data for defining a language specific information package for the UDT; and
an output for providing the information package to a storage directory such that the information package is accessible by an application interacting with the database.

2. A system according to claim 1 wherein the language specific information package is a Java class file representative of the UDT.

3. A system according to claim 2 wherein the processor defines a first data packet indicative of Java source code for the UDT.

4. A system according to claim 3 wherein the processor compiles the Java source code to define a second data packet indicative of the Java class file.

5. A system according to claim 4 wherein the second packet includes data indicative of class file byte codes for the Java class file.

6. A system according to claim 4 wherein the processor leverages a Java compiler inherent to the database for compiling Java source code to define the Java class file.

7. A system according to claim 6 wherein the processor is responsive to an alteration to the Java source code for making a corresponding alteration to the Java class file.

8. A system according to claim 6 wherein the database implements a gateway volume, and the second data packet is accessible to the Java application through the gateway volume.

9. A system according to claim 8 where in the gateway volume includes either or both of a CIFS gateway process and a NFS gateway.

10. A system according to claim 8 wherein the Java application has a classpath including the gateway volume.

11. A system according to claim 3 wherein the storage directory includes a CLOB column for maintaining the first data packet.

12. A system according to claim 4 wherein the storage directory includes a BLOB column for maintaining the second data packet.

13. A system according to claim 2 wherein the database implements a predefined JDBC protocol having a SQLData interface, and the processor leverages the SQLData interface for defining the Java class.

14. A system according to claim 1 wherein the storage directory is a data dictionary table.

15. A system according to claim 14 wherein the table holds a definition for the UDT.

16. A database including:
a UDT definition; and
a table including a column for maintaining a Java class file representative of the UDT definition, the column being accessible by a Java application.

17. A database according to claim 16 wherein the database includes a data dictionary, and the column is a BLOB column within this data dictionary.

18. A database according to claim 16 including a system for automatically defining the Java class file in response to creation or modification of a UDT for the database.

19. A method for managing a user defined type (UDT) in a database, the method including the steps of:
receiving data indicative of the UDT;
being responsive to the data for defining a language specific information package for the UDT; and
providing the information package to a storage directory such that the information package is accessible by an application interacting with the database.
